(19) United States
(12) Patent Application Publication
(10) Pub. No.: US 2022/0334822 A1
(43) Pub. Date: Oct. 20, 2022

(54) METHOD FOR UPDATING SOFTWARE IN VEHICLE CONTROLLER AND VEHICLE OPERATING SYSTEM

(71) Applicant: TOYOTA JIDOSHA KABUSHIKI KAISHA, Aichi-ken (JP)

(72) Inventors: Kosuke SAKAKIBARA, Toyota-shi (JP); Yoichi ONISHI, Okazaki-shi (JP); Kenji KANAMORI, Nagoya-shi (JP); Yusuke MATSUKAWA, Nagoya-shi (JP); Kei KAWASAKI, Kariya-shi (JP); Mahito OSUKA, Kariya-shi (JP); Keisuke SAITO, Kariya-shi (JP)

(21) Appl. No.: 17/723,482

(22) Filed: Apr. 19, 2022

(30) Foreign Application Priority Data
Apr. 20, 2021 (JP) 2021-070809

(51) Int. Cl. G06F 8/65; B60L 58/12; G01C 21/34; G01C 21/36; H04W 4/44

(52) U.S. Cl. CPC G06F 8/65; B60L 58/12; G01C 21/3438; G01C 21/3685; H04W 4/44

(57) ABSTRACT

A software updating method for transmitting update data for software installed in vehicle controllers via wireless communication from an operation managing server to a plurality of vehicles on which the vehicle controllers are respectively mounted, for causing each of the vehicle controllers to update the software, in which the operation managing server is configured to group the plurality of vehicles into a plurality of groups, and vary timings of causing the vehicle controllers to update the software on a group-by-group basis.

### CROSS REFERENCE TO RELATED APPLICATION

This application claims priority to Japanese Patent Application No. 2021-070809 filed on Apr. 20, 2021, which is incorporated herein by reference in its entirety including the specification, claims, drawings, and abstract.

### TECHNICAL FIELD

The present disclosure relates to a software updating method and a vehicle operating system, in which data for updating software installed in a vehicle controller is transmitted via wireless communication to a vehicle to update the software in the vehicle controller.

### BACKGROUND

Systems for updating software of vehicle controllers through wireless communication have been suggested (see, for example, JP 2018-132979 A).

In a system disclosed in JP 2018-132979 A (hereinafter referred to as the '979 application), a software updating device mounted on a vehicle communicates with a telematics center after an engine is started, to determine whether or not software in a control device requires updating, and, when it is determined that the software requires updating, requests a software program used for the update from the telematics center. Then, after downloading the software program, the software updating device updates the software in response to an installation start command from the telematics center.

Meanwhile, vehicle operating systems for self-driving vehicles have been utilized in recent years. Such a system is often configured to operate a plurality of self-driving vehicles. Because, with the software updating method described in the ′979 application, a plurality of self-driving vehicles may update their software at the same time, the result in some instances may be a situation where operation of a sufficient number of the self-driving vehicles becomes impossible. Further, because in the software updating method of the ′979 application the software is updated when the engine is started, in some instances the plurality of vehicles cannot be operated for a period of time after the start of the engine until the software updated has been completed, which may make it impossible to operate plural vehicles as desired.

Under these circumstances, the present disclosure is directed to preventing software in vehicle controllers from being updated concurrently in the vehicle controllers, to thereby secure operation of a plurality of vehicles.

### SUMMARY

A software updating method of this disclosure includes transmitting data for updating software in vehicle controllers (“update data”) via wireless communication from a server to a plurality of vehicles on which the vehicle controllers are respectively mounted, for causing each of the vehicle controllers to update the software, in which method the server groups the plurality of vehicles into a plurality of groups and varies timings of causing the vehicle controllers to update the software on a group-by-group basis.

In this way, concurrent updating of the software in the vehicle controllers can be prevented, to thereby secure operation of sufficient vehicles.

In the software updating method of this disclosure, the server may be configured to vary the timing of transmission of the update data to the vehicles on a group-by-group basis.

When the timing of transmission of the update data to the vehicles is varied from group to group, the communication load between an operation managing server and each of the vehicles can be reduced, while also preventing concurrent updating of the software in vehicle controllers, to accordingly secure operations of the vehicles.

In the software updating method of this disclosure, the server may be configured to set an update timing of causing the vehicle controllers mounted on the vehicles in each of the plurality of groups to update the software in such a manner that the update timing is varied on a group-by-group basis, and transmit both the update data and the update timing to the vehicles in each of the groups.

Because the update timing is transmitted together with the update data to each of the vehicles as described above, a transmission timing of transmitting the update data to the vehicle can be flexibly specified for each of the groups.

In the software updating method of this disclosure, the server may be an operation managing server which manages operations of the plurality of vehicles, and the operation managing server may be configured to acquire information on present locations from the plurality of vehicles, identify among the plurality of vehicles two or more vehicles parked in a parking space, and group the identified two or more vehicles in separate groups.

According to the above-described configuration, concurrent updating of the software of the two or more vehicles parked in the parking space can be prevented.

In another aspect of this disclosure, a software updating method includes transmitting update data for software in vehicle controllers via wireless communication from a software managing server to a plurality of vehicles on which the vehicle controllers are respectively mounted, for causing each of the vehicle controllers to update the software, in which method the software managing server is configured to transmit the update data to the plurality of vehicles, an operation managing server which manages operations of the plurality of vehicles is configured to acquire from the software managing server information indicating that the update data is transmitted, and the operation managing server is further configured to group, upon acquisition of the information, the plurality of vehicles into a plurality of groups, and vary timings of causing the vehicle controllers to update the software on a group-by-group basis.

In the software updating method of this disclosure, the operation managing server may be configured to set an update timing of updating the software in vehicle controllers mounted on vehicles in each of the groups, the update timing being varied on a group-by-group basis, and transmit the update timing to the vehicles, and each of the vehicle controllers may be configured to update the software upon receipt of the update timing.

In this way, concurrent updating of the software installed in the vehicle controllers can be prevented from occurring, to thereby secure operation of sufficient vehicles.

In the software updating method of this disclosure, the vehicles may be battery electric vehicles, and the operation managing server may be configured to acquire information about a present state of charge of a battery from each of the plurality of vehicles, and group the plurality of vehicles parked in a parking space into a plurality of groups in such a manner that vehicles having batteries whose state of charge differ from each other are contained in a same one group.

The above-described configuration can prevent a situation wherein, among the battery electric vehicles, all dispatchable battery electric vehicles having fully charged batteries are contained in the same one group and concurrently start updating the software, without leaving a single vehicle that is immediately dispatchable.

In the software updating method of this disclosure, the operation managing server may include a vehicle status database which stores maintenance statuses of the plurality of vehicles, and may be configured to group the plurality of vehicles parked in the parking space into a plurality of groups in such a manner that, among the plurality of vehicles, those having different time periods until a next scheduled maintenance are contained in a same one group.

This can prevent a situation wherein all vehicles having a relatively long time period until a next scheduled maintenance and are accordingly capable of a long distance driving, are grouped under the same one group, and thus concurrently start updating the software without leaving a single vehicle capable of a long distance driving.

In the software updating method of this disclosure, the plurality of vehicles may be a plurality of self-driving taxies, and the operation managing server may include a reservation information database which stores information about reservations of the plurality of self-driving taxies, and may be configured to group, among the plurality of self-driving taxies, those parked in a parking space into a plurality of groups based on the information about reservations.

In this way, it can be prevented that software updating is initiated immediately before a starting time of a reserved operation.

In the software updating method of this disclosure, the plurality of vehicles may be a plurality of shared vehicles, and the operation managing server may include a reservation information database which stores information about reservations of the shared vehicles, and may be configured to group, among the plurality of shared vehicles, shared vehicles parked in the parking space into a plurality of groups based on the information about reservations.

Also in this way, the update of the software can be prevented from being initiated immediately before the starting time of a reserved operation.

In the software updating method of this disclosure, the server may be an operation managing server which manages operations of a plurality of vehicles, and the operation managing server may be configured to acquire information on present locations from the plurality of vehicles, identify, among the plurality of vehicles, two or more vehicles parked in the parking space, group the identified two or more vehicles into a plurality of groups, transmit the update data for the software to a test vehicle in a first group which is, among the plurality of groups, initially subjected to an update of the software, so as to cause a vehicle controller mounted on the test vehicle to perform the update of the software at a first timing preceding by a predetermined length of time an update of the software in vehicle controllers mounted on other vehicles in the first group, transmit the update data to the other vehicles in the first group so as to cause the vehicle controllers of the other vehicles to perform the update of the software at a second timing after the predetermined length of time from the first timing, and transmit the update data to vehicles in each of second and subsequent groups in the plurality of groups so as to cause vehicle controllers of the vehicles in the second and subsequent groups to sequentially perform the update of the software at timings subsequent to the second timing, the timings being varied on a group-by-group basis, in which the predetermined length of time may be a sum of a length of time required to update the software in the vehicle controller mounted on the test vehicle and a length of time required to complete a test run of the test vehicle after the update of the software.

In the software updating method of this disclosure, the server may be an operation managing server which manages operations of a plurality of vehicles, the operation managing server may be configured to acquire information on present locations from the plurality of vehicles, identify, among the plurality of vehicles, two or more vehicles parked in a parking space, group the identified two or more vehicles into a plurality of groups, set an update timing of updating the software in a vehicle controller mounted on a test vehicle in a first group which is, among the plurality of groups, initially subjected to an update of the software, so as to cause the vehicle controller mounted on the test vehicle to perform the update of the software at a first timing preceding by a predetermined length of time an update of the software in vehicle controllers of other vehicles in the first group, set an update timing of updating the software in the vehicle controllers of the other vehicles, so as to cause the vehicle controllers of the other vehicles to perform the update of the software at a second timing after the predetermined length of time from the first timing, and set an update timing of updating the software in vehicle controllers mounted on vehicles in each of second and subsequent groups in the plurality of groups, so as to cause the vehicle controllers of the vehicles in the second and subsequent groups to sequentially update the software at timings subsequent to the second timing, the timings being varied on a group-by-group basis, in which the predetermined length of time is a sum of a length of time required to update the software in the vehicle controller of the test vehicle and a length of time required to perform a test run of the test vehicle after the update of the software.

In this way, because the software is updated in the vehicle controllers of the vehicles other than the test vehicle only after both the update of the software in the vehicle controller of the test vehicle and the test run of the test vehicle are completed, in the event that driving of the test vehicle is affected by an error in updated software, a situation where all of the vehicles are rendered undrivable by the error can be prevented.

In an aspect of this disclosure, a vehicle operating system is provided, in which the vehicle operating system includes a plurality of vehicles on which vehicle controllers are respectively mounted, and an operation managing server which manages operations of the plurality of vehicles, the system in which the operation managing server is configured to transmit update data for software in the vehicle controllers mounted on the plurality of vehicles via wireless communication to the plurality of vehicles, each of the vehicle controllers respectively mounted on the plurality of vehicles is configured to update the software upon receipt of the update data transmitted from the operation managing server, and the operation managing server is further configured to group the plurality of vehicles into a plurality of groups, and vary timings of causing the vehicle controllers to update the software on a group-by-group basis.

With the above-described configuration, operation of the vehicles can be secured by preventing concurrent updating of the software in the vehicle controllers.

In the vehicle operating system of this disclosure, the operation managing server may be configured to vary transmission timings of transmitting the update data to the vehicles on a group-by-group basis.

In the vehicle operating system of this disclosure, the operation managing server may be configured to set update timings of updating the software in such a manner that the software is updated in vehicle controllers mounted on vehicles in each of the plurality of groups at a different update timing that is varied on a group-by-group basis, and transmit both the update data and the update timing to the vehicles.

In the vehicle operating system of this disclosure, the operation managing server may be configured to acquire information on present locations from the plurality of vehicles, identify, among the plurality of vehicles, two or more vehicles parked in a parking space, and group the identified two or more vehicles into a plurality of groups.

In an aspect of this disclosure, a vehicle operating system includes a plurality of vehicles on which vehicle controllers are respectively mounted, an operation managing server which manages operations of the plurality of vehicles, and a software managing server which transmits update data for software in the vehicle controllers via wireless communication to the plurality of vehicles, in which vehicle operating system the operation managing server is configured to acquire from the software managing server information indicating that the update data is transmitted, the operation managing server is further configured to group, upon acquisition of the information, the plurality of vehicles into a plurality of groups, and vary timings of updating the software in the vehicle controllers on a group-by-group basis.

In the vehicle operating system of this disclosure, the operation managing server may be configured to set an update timing of updating the software in vehicle controllers mounted on vehicles contained in each of the groups, the update timing being varied on a group-by-group basis, and transmit the update timing to the vehicles, and each of the vehicle controllers may be configured to update the software upon receipt of the update timing. In addition, the operation managing server may be further configured to acquire information on present locations from the plurality of vehicles, identify, among the plurality of vehicles, two or more vehicles that are parked in a parking space, and group the identified two or more vehicles into a plurality of groups.

According to the present disclosure, concurrent updating the software in the vehicle controllers can be prevented, to thereby secure operation of the vehicles.

### BRIEF DESCRIPTION OF DRAWINGS

Embodiments of the present disclosure will be described based on the following figures, wherein:

FIG. 1 is a system diagram showing a configuration of a vehicle operating system according to an embodiment;

FIG. 2 is a schematic diagram showing a configuration of a vehicle utilized in the vehicle operating system according to the embodiment;

FIG. 3 is a diagram showing control blocks in the vehicle illustrated in FIG. 2;

FIG. 4 is a diagram showing a configuration of an operation managing center illustrated in FIG. 1 and control blocks in an operation managing server;

FIG. 5 is a diagram showing a data structure in a vehicle status database;

FIG. 6 is a diagram showing a data structure in a reservation information database;

FIG. 7 is a flowchart showing action of the operation managing server;

FIG. 8 is a flowchart showing alternative steps in a grouping process illustrated in FIG. 7;

FIG. 9 is a flowchart showing further alternative steps in the grouping process illustrated in FIG. 7;

FIG. 10 is a flowchart showing another example of action of the operation managing server;

FIG. 11 is a timing chart showing update timings of updating software in a vehicle controller of a test vehicle in a first group, updating software installed in vehicle controllers of other vehicles in the first group, and updating software of vehicle controllers in vehicles in second and subsequent groups;

FIG. 12 is a diagram showing another configuration of the operation managing center and control blocks in another operation managing server according to another embodiment;

FIG. 13 is a flowchart showing action of the operation managing server illustrated in FIG. 12:

FIG. 14 is a system diagram showing the vehicle operating system according to another embodiment;

FIG. 15 is a diagram showing another example of the control blocks in the vehicle illustrated in FIG. 2;

FIG. 16 is a diagram showing a configuration of the operation managing center and control blocks in the operation managing server illustrated in FIG. 14;

FIG. 17 is a flowchart showing action of the operation managing server illustrated in FIG. 14;

FIG. 18 is a flowchart showing action of the vehicle 10 illustrated in FIG. 14; and

FIG. 19 is a flowchart showing action of the operation managing server illustrated in FIG. 14.

### DESCRIPTION OF EMBODIMENTS

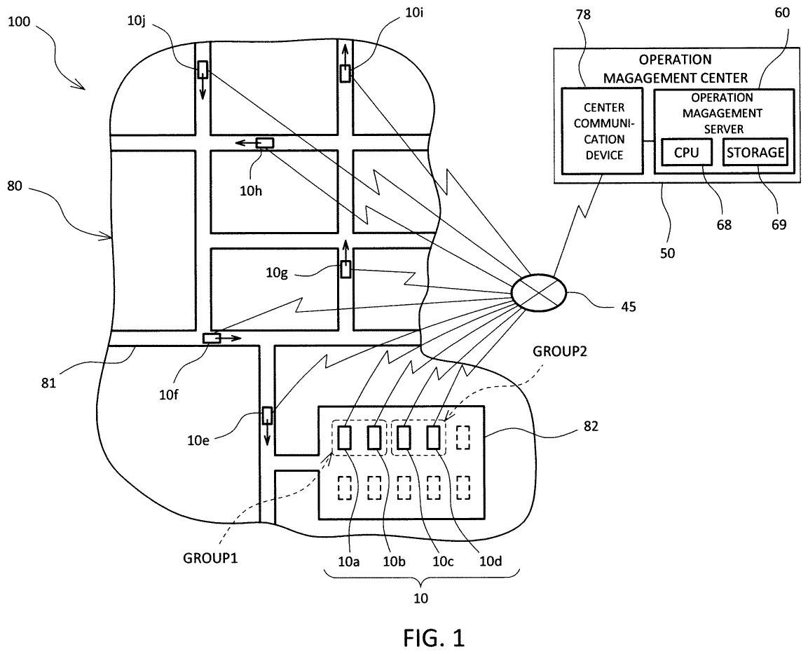

Hereinafter, a vehicle operating system 100 according to an embodiment will be described with reference to the drawings. As shown in FIG. 1, the vehicle operating system 100 according to the embodiment is a system for operating a plurality of vehicles 10 capable of self-driving within a predetermined operation area 80. The plurality of vehicles 10 are self-driving taxies which travel via automated self-driving within the operation area 80 based on commands from an operating managing server 60 installed in an operation managing center 50. The operation managing server 60 is connected to each of the vehicles 10 through a wireless communication channel 45. The operation managing server 60 is a computer incorporating a CPU 68 for performing information processing and a storage 69 for storing data, such as an operation program, operation data, and a database. The vehicle operating system 100 in this embodiment is explained with reference to operations of ten vehicles 10. Hereinafter, the ten vehicles 10 are respectively referred to as a vehicle 10a, 10b, . . . or 10j when there is a need to distinguish the ten vehicles 10 from each other, or referred to as the vehicle 10 when there is no need to individually distinguish the ten vehicles 10. FIG. 1 shows a situation in which four vehicles 10a to 10d are parked in a parking space 82 established within the operation area 80, and other six vehicles 10e to 10j are traveling on roads 81 established within the operation area 80. Here, the parking space 82 may be a service office for self-driving taxies, a taxi pool, or other types of parking area.

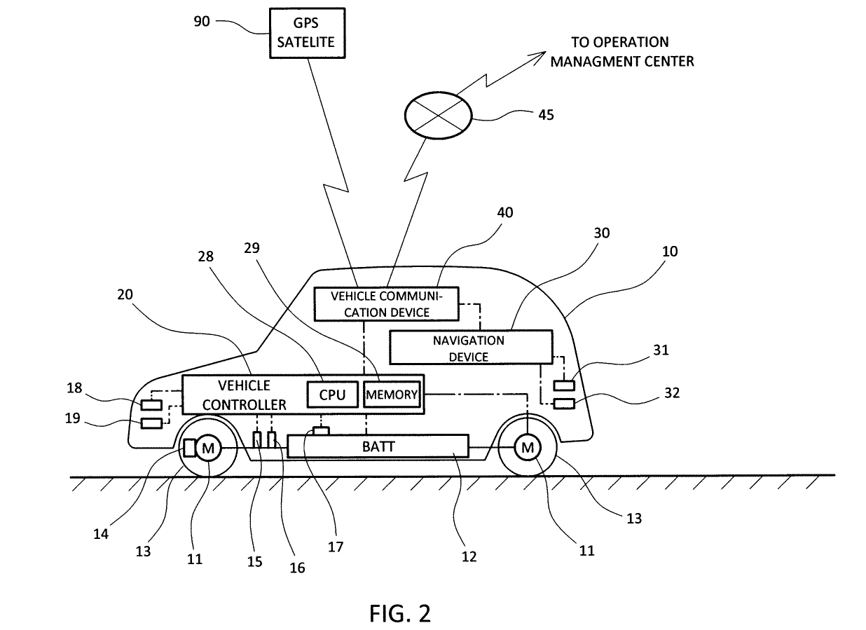

As shown in FIG. 2, the vehicle 10, which is a battery electric vehicle capable of self-driving, is equipped with a motor 11 for driving, a battery 12 for supplying drive power to the motor 11, a steering device 14 for adjusting a steering angle of a wheel 13, a vehicle controller 20, a navigation device 30, and a vehicle communication device 40.

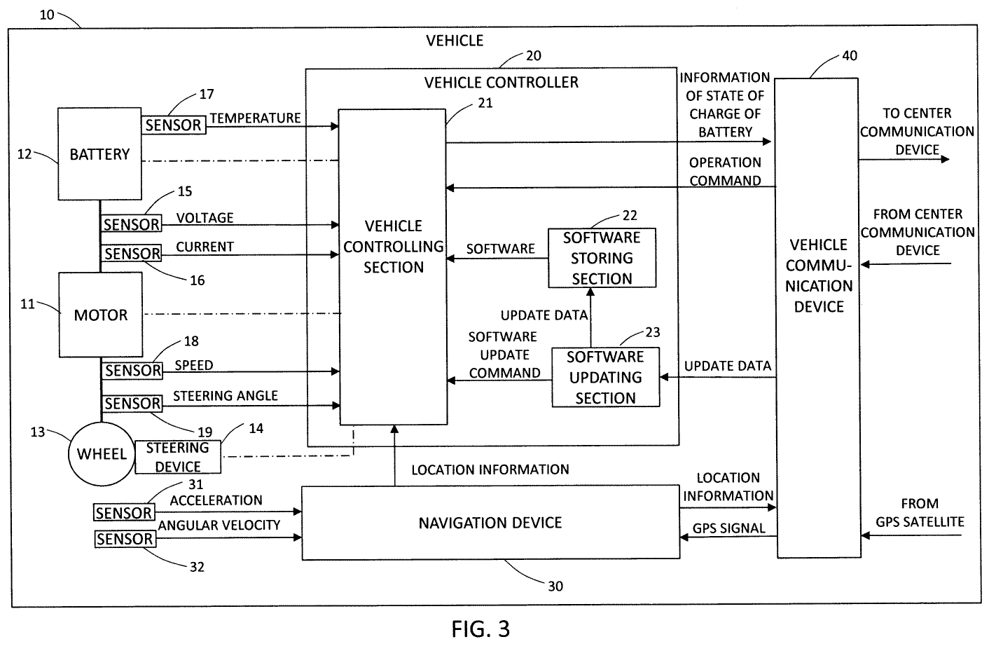

The vehicle controller 20 is a computer incorporating a CPU 28 which performs information processing and a memory 29 which stores software and other programs executed by the CPU 28 and data. As shown in FIG. 3, within the vehicle controller 20 are three control blocks consisting of a vehicle controlling section 21 for controlling travel of the vehicles 10, a software storing section 22 for storing software executed by the vehicle controlling section 21, and a software updating section 23. The software storing section 22 is implemented by the memory 29. The vehicle controlling section 21 is implemented by executing, with the CPU 28, the software stored in the software storing section 22. Further, the software updating section 23 is implemented by executing, with the CPU 28, a software updating program stored in the memory 29. It should be noted that the vehicle controller 20 is not completely terminated when the vehicle 10 is shut down, and several functions of the vehicle controller 20 remain active in order to control temperature and a charging operation in the battery 12.

The motor 11, the battery 12, and the steering device 14 are connected to the vehicle controlling section 21 in the vehicle controller 20. A voltage sensor 15 and a current sensor 16 are disposed between the battery 12 and the motor 11 to respectively detect a voltage and a current of electric power supplied from the battery 12 to the motor 11. Further, a temperature sensor 17 is attached to the battery 12 to detect the temperature of the battery 12. Still further, a vehicle speed sensor 18 and a steering angle sensor 19 are disposed between the motor 11 and the wheel 13 to detect a vehicle speed and a steering angle of the wheel 13, respectively. The voltage sensor 15, the current sensor 16, the temperature sensor 17, the vehicle speed sensor 18, and the steering angle sensor 19 are connected to the vehicle controlling section 21 in the vehicle controller 20.

An acceleration sensor 31 and an angular velocity sensor 32 for detecting an acceleration and an angular velocity of the vehicle 10, respectively, are mounted on the vehicle 10. Both the acceleration sensor 31 and the angular velocity sensor 32 are connected to the navigation device 30. The navigation device 30 identifies the present location of the vehicle 10 based on a GPS signal acquired via the vehicle communication device 40 from a GPS satellite 90 and based on information of the acceleration and the angular velocity of the vehicle 10 respectively acquired from the acceleration sensor 31 and the angular velocity sensor 32, and outputs information on the present location of the vehicle 10 to the vehicle controlling section 21. In addition, the navigation device 30 outputs the information on the present location of the vehicle 10 to the operation managing center 50 via the wireless communication channel 45. It should be noted that the navigation device 30 outputs the information on the present location to the operation managing center 50 even though the vehicle 10 is shut down.

The vehicle controlling section 21 is configured by executing the software stored in the software storing section 22 with the CPU 28, to control the motor 11, the battery 12, and the steering device 14 based on an operation command input from the operation managing center 50, the information on the present location input from the navigation device 30, and data input from the variety of sensors 15 to 19 for causing the vehicle 10 to travel via automated self-driving. The vehicle controlling section 21 is further configured to acquire the voltage, current, and temperature of the battery 12 from the voltage sensor 15, the current sensor 16, and the temperature sensor 17, calculate, based on the acquired voltage, current, and temperature, a state of charge of the battery 12, and transmit information on the calculated state of charge of the battery 12 to the operation managing center 50.

The software updating section 23 stores data for updating software (“update data”) transmitted from the operation managing center 50 in the software storing section 22 and outputs a software update command to the vehicle controlling section 21.

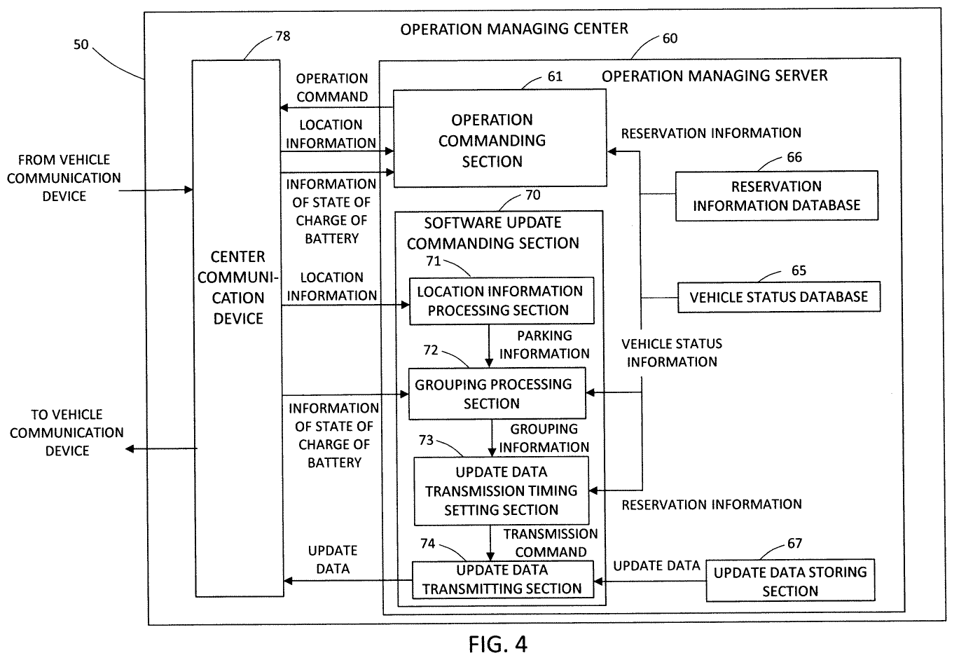

As shown in FIG. 4, the operation managing center 50 includes the operation managing server 60 for managing operations of the vehicles 10 and a center communication device 78. The operation managing server 60 is, as described above, a computer composed of the CPU 68 for performing information processing and the storage 69 for storing data, such as an operation program, operation data, and a database, and includes control blocks consisting of an operation commanding section 61, a software update commanding section 70, a vehicle status database 65, a reservation information database 66, and an update data storing section 67. The software update commanding section 70 in turn comprises control blocks consisting of a location information processing section 71, a grouping processing section 72, an update data transmission timing setting section 73, and an update data transmitting section 74.

The operation commanding section 61 and the location information processing section 71, the grouping processing section 72, the update data transmission timing setting section 73, and the update data transmitting section 74 in the software update commanding section 70 are implemented by programs stored in the storage 69 when the CPU 68 executes the programs. Further, the vehicle status database 65, the reservation information database 66, and the update data storing section 67 are implemented by data having a predetermined data structure stored in the storage 69.

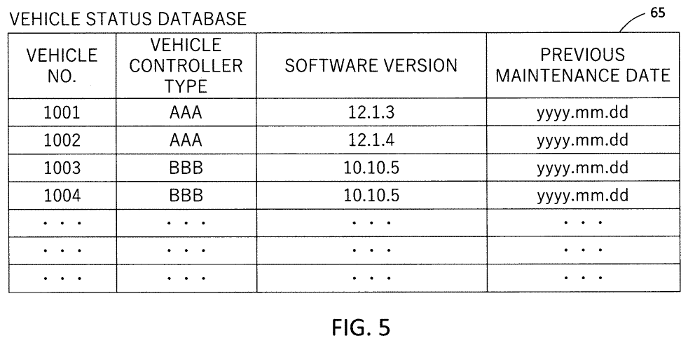

As shown in FIG. 5, the vehicle status database 65 is a database in which vehicle numbers, type of the vehicle controlling device 20, information on versions of running software, and maintenance statuses, such as previous maintenance dates, are stored in a mutually associated form.

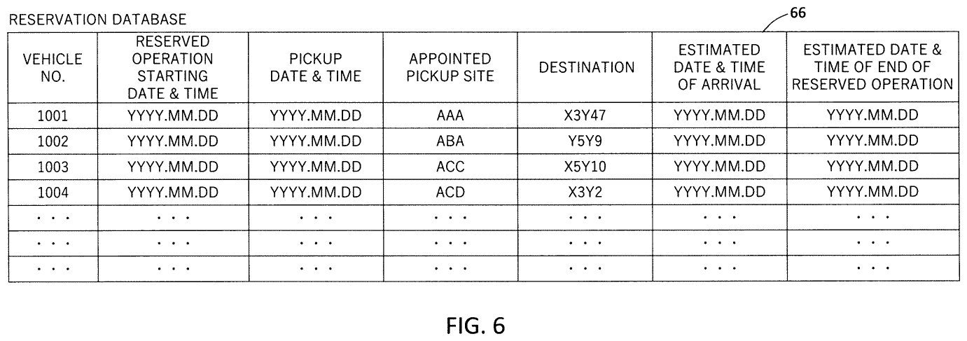

As described above, the vehicles 10 are operated as automated self-driving taxies. The reservation information database 66 is, as shown in FIG. 6, a database in which the vehicle numbers, reserved operation starting dates and times, pickup dates and times, appointed pickup sites, destinations, estimated dates and times of arrival, and estimated dates and times of end of reserved operation are stored in a mutually associated form. Here, the reserved operation starting date and time represents a date and time at which the vehicle 10 leaves the parking space 82 in order to carry out a reserved operation, and the estimated date and time of end of reserved operation represents an estimated date and time at which the vehicle 10 will return to the parking space 82 after sending a passenger to a destination. The update data storing section 67 shown in FIG. 4 stores data used for updating software which is presently running on the vehicle controller 20 of the vehicle 10.

The operation commanding section 61 outputs to each of the vehicles 10 an operation command based on information on a location and a state of charge of the battery 12 acquired from each of the vehicles 10 and based on reservation data stored in the reservation information database 66. The operation command includes information on the destination, a time of arrival, a route, and the like. Each of the vehicles 10 travels in an autonomous self-driving manner according to the received operation command, in order to accomplish its task as an autonomous self-driving taxi.

The location information processing section 71 in the software update commanding section 70 identifies, from among the vehicles 10, vehicles 10 parked in the parking space 82 shown in FIG. 1, based on the location information acquired from the vehicles 10. The grouping processing section 72 groups, based on parking information acquired from the location information processing section 71, the vehicles 10 parked in the parking space 82 into a plurality of groups. The update data transmission timing setting section 73 sets, for each of the groups, a transmission timing of transmitting update data for the software to vehicles 10 belonging to each of the groups, and outputs, at the transmission timing having been set, an update data transmission command to the update data transmitting section 74. The update data transmitting section 74 transmits, in response to an input of the transmission command, update data for the software stored in the update data storing section 67 toward each of the vehicles 10 contained in a specified one of the groups. Here, the transmission timing may be specified as a point in time at which the update data is transmitted, or a time interval between transmissions. When the transmission timing is specified using the time interval, the transmission of the update data to the vehicles 10 in each of the groups is performed at the specified time interval on a group-by-group basis.

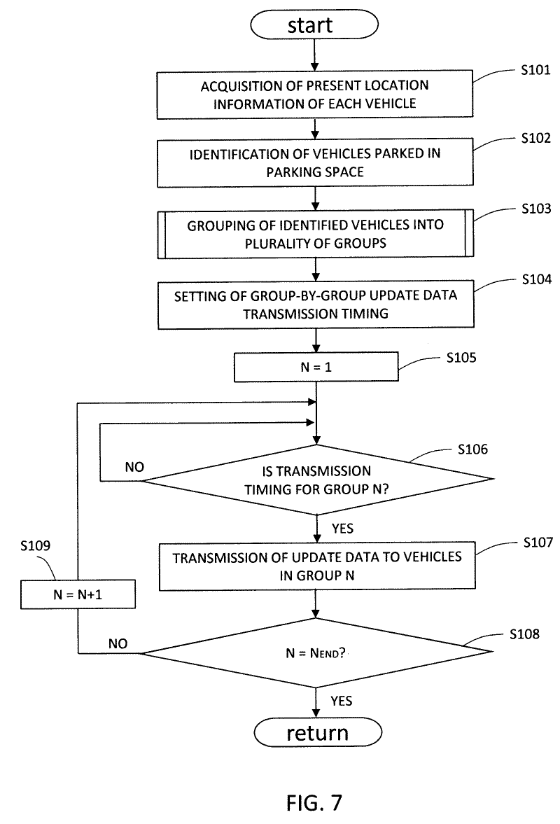

Next, action of the operation managing server 60 in the thus-configured vehicle operating system 100 to perform an update of the software installed in the vehicle controller 20 of the vehicle 10 will be described with reference to FIG. 7.

In FIG. 7, as shown in step S101, the location information processing section 71 in the software update commanding section 70 acquires information on a location of each of the vehicles 10 from the vehicles 10, and identifies, from among the vehicles 10, those parked in the parking space 82 as shown in step S102.

When the four vehicles 10a to 10d are parked in the parking space 82 as illustrated in FIG. 1, present positions of the vehicles 10a to 10d remain unchanged regardless of a lapse of time, while present positions of the other vehicles 10e to 10j change with a lapse of time. Based on the present positions, the location information processing section 71 identifies the vehicles 10a to 10d parked in the parking space 82 in step S102 of FIG. 7.

Then, the grouping processing section 72 groups the vehicles 10a to 10d parked in the parking space 82 into a plurality of groups in step S103 of FIG. 7. For example, the grouping processing section 72 groups the vehicles 10 and 10b under a first group and the vehicles 10c and 10d under a second group as illustrated in FIG. 1.

Subsequently, the update data transmission timing setting section 73 sets a transmission timing of transmitting the update data for the software to the vehicles 10 belonging to each of the groups in step S104 of FIG. 7. The transmission timing is varied on a group-by-group basis. In the above-described example, the transmission timing is defined such that transmission to the vehicles 10a and 10b in the first group is set at 12:00, and transmission to the vehicles 10c and 10d in the second group is set at 14:00.

The update data transmission timing setting section 73 sets a value of 1 to N in a counter as shown in step S105 of FIG. 7, moves to step S106 of FIG. 7, and waits until the transmission timing set to the first groups, Group 1 arrives. At the transmission timing set to Group 1, the update data transmission timing setting section 73 determines Yes in step S106 of FIG. 7, and moves to step S107 of FIG. 7 to read the update data for the software from the update data storing section 67 and transmit the read update data to the vehicles 10a and 10b belonging to Group 1.

Upon completion of transmission, the update data transmission timing setting section 73 moves to step S108 of FIG. 7 to determine whether or not the update data is transmitted to vehicles 10 in the final group, Group Nend. When No is determined in step S108 of FIG. 7, the update data transmission timing setting section 73 increments the value of N by one, returns to step S106 of FIG. 7, waits for a transmission timing set to a next group, and moves to step S107 of FIG. 7 at the transmission timing of the next group to transmit the update data to vehicles 10 in the next group.

Upon receipt of the update data for software from the operation managing server 60 in the operation managing center 50, the software updating section 23 in the vehicle controller 20 mounted on each of the vehicles 10a and 10b in Group 1 stores the received update data in the software storing section 22. After storing the update data, the software updating section 23 outputs the software update command to the vehicle controlling section 21.

The vehicle controlling section 21 terminates all currently active software applications, shuts down the vehicle controller 20, and subsequently reads the update data from the software storing section 22 to execute an update of the software.

The update data for the software is transmitted to the vehicles 10c and 10d in Group 2 is transmitted after a slight delay from transmission to the vehicles 10a and 10b in Group 1. Therefore, after the update of the software in the vehicle controller 20 is finished in each of the vehicles 10a and 10b in Group 1, each of the vehicles 10c and 10d in Group 2 receives the update data and updates the software in the vehicle controller 20.

As described above, in the vehicle operating system 100 according to this embodiment, the transmission timing of transmitting the update data to the vehicles 10 in each of the groups is varied on a group-by-group basis, which can prevent concurrent updates of the software in the vehicle controllers 20 from occurring in all of the vehicles 10. In addition, when the transmission timing of transmitting the update data to the vehicles 10 is varied on a group-by-group basis, the update data for the software can be transmitted while suppressing a load on communication between the operation managing server 60 and each of the vehicles 10.

In the above description, although the grouping processing section 72 is explained in connection with a process of grouping the vehicles 10a to 10d parked in the parking space 82 into two groups, the grouping processing section 72 is not limited to the process, and may be configured to group the four vehicles 10 into four groups on a one-by-one basis. Alternatively, the four vehicles 10 may be grouped into two groups of a first group containing one vehicle and a second group containing three vehicles, or into three groups of first and second groups respectively containing one vehicle and a third group containing two vehicles. In addition, the operation area 80 of the vehicles 10 may include, as the parking space 82, a plurality of parking spaces 82.

In cases wherein the plurality of parking spaces 82 are present, it is essential that vehicles 10 parked in a same one parking space 82 are grouped under different groups, while a same one group may include vehicles 10 parked in different parking spaces 82. For example, assuming that the vehicles 10a and 10b are parked in one of the parking spaces 82 and the vehicles 10c and 10d are parked in another one of the parking spaces 82, the vehicle 10a and 10c may be grouped under the first group, while the vehicles 10b and 10d may be grouped under the second group. As a result, the vehicles 10 parked in each of the parking spaces 82 are grouped into two groups of the first group and the second group. Conversely, each of the groups contains the vehicles 10 parked in the one of the parking spaces 82.

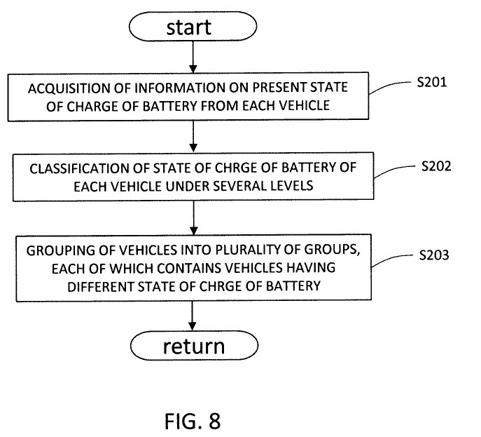

Referring next to FIG. 8, another grouping process performed in the grouping processing section 72 is described. In this grouping process, information on present state of charge of batteries 12 is acquired from the vehicles 10 in the step of grouping shown in step S103 of FIG. 7, and the vehicles 10 parked in the parking space 82 are grouped into a plurality of groups in such a manner that among the vehicles 10 in the parking space 82, those having batteries 12 whose state of charge differ from each other are grouped under a same one group.

As shown in step S201 of FIG. 8, the grouping processing section 72 in the operation managing server 60 acquires information on the present state of charge of the battery 12 from each of the vehicles 10. Then, in step S202 of FIG. 8, the grouping processing section 72 classifies the acquired state of charge of the batteries 12 in the vehicles 10 under several levels. For example, the state of charge are classified under three levels consisting of a recharge requiring charge level at which a remaining capacity of the battery 12 is 50% or lower, a drivable charge level at which the remaining capacity is from 50% to 80%, and a full charge level at which the remaining capacity is from 80% to 100%.

Then, as shown in step S203 of FIG. 8, the grouping processing section 72 groups the vehicles 10 parked in the parking space 82 into a plurality of groups in such a manner that, among the vehicles 10 in the parking space 82, vehicles 10 having batteries 12 whose state of charge are classified under different charge levels are contained in a same one group. For example, assuming that six vehicles 10 are parked in the parking space 82, the six vehicles 10 are grouped in such a manner that each of the groups includes a vehicle 10 classified under the full charge level, a vehicle 10 classified under the drivable charge level, and a vehicle 10 classified under the recharge requiring charge level.

In this way, including all vehicles 10 whose batteries 12 have been fully charged and are categorized under the full charge level of being dispatchable in the same one group, and thus concurrently starting action of updating the software without leaving a single vehicle 10 having a battery 12 at the full charge level and capable of being dispatched at any moment, can be prevented.

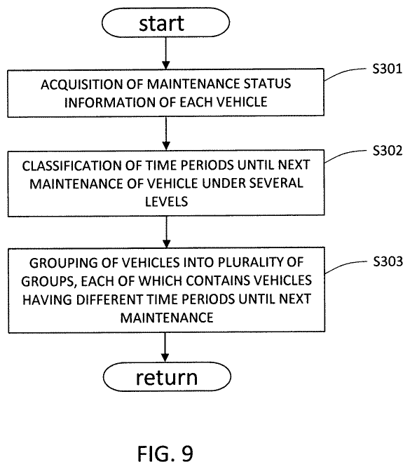

Next, a further grouping process performed in the software update commanding section 70 is described with reference to FIG. 9. In this grouping process, the vehicles 10 are grouped based on a time period until a next scheduled maintenance allocated to each of the vehicles 10 rather than the state of charge of the battery 12 as in the previous grouping process explained with reference to FIG. 8.

As shown in step S301 of FIG. 9, the grouping processing section 72 refers to the vehicle status database 65 to retrieve data of a previous maintenance date of each of the vehicles 10 parked in the parking space 82. Then, the grouping processing section 72 calculates a time period until a next scheduled maintenance for each of the vehicles 10 in step S302 of FIG. 9, and categorizes calculated time periods under several levels.

In subsequent step S303 of FIG. 9, the grouping processing section 72 groups the vehicles 10 parked in the parking space 82 into a plurality of groups in such a manner that, among the vehicles 10, those having different time periods until the next scheduled maintenance are contained in a same one group.

In this way, including all vehicles 10 having a long time period until the next scheduled maintenance and thus being capable of a long distance drive in the same one group, without leaving a single vehicle capable of driving a long distance, can be prevented.

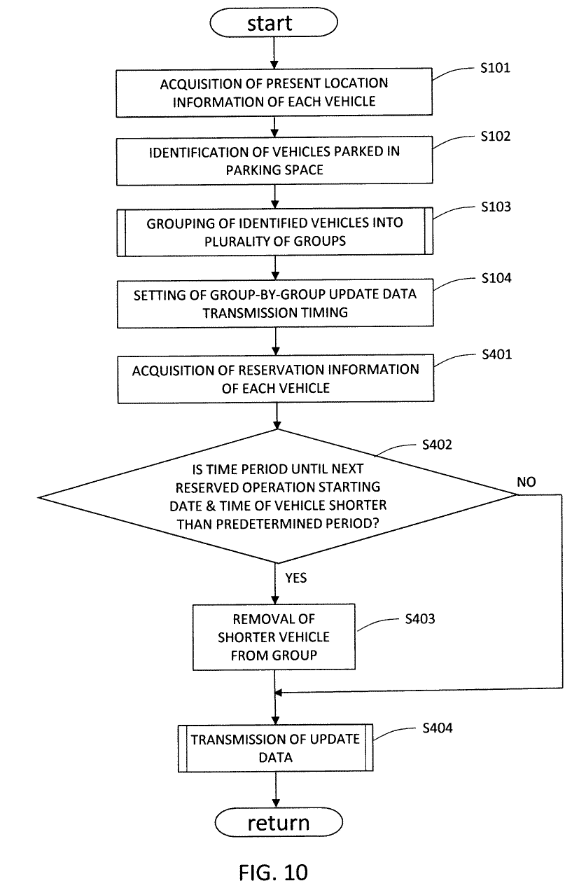

Hereinafter, action of performing the update of the software in consideration of reservation statuses of the vehicles 10 is explained with reference to FIG. 10. In FIG. 10, steps of performing the same processings as those shown in FIG. 7 are designated by the same reference sings as those in FIG. 7, and the descriptions related to the steps will not be repeated.

The update data transmission timing setting section 73 sets the transmission timing of transmitting the update data for each of the groups in step S104 of FIG. 10, moves to step S401 of FIG. 10 to acquire data about a reserved operation starting date and time of each of the vehicles 10 through an access to the reservation information database 66. Then, in step S402 of FIG. 10, the update data transmission timing setting section 73 determines whether or not a time period until a next reserved operation starting date and time of each of the vehicles 10 is shorter than a predetermined time period. When any vehicle 10 is identified as having a shorter time period in step S402 of FIG. 10, the update data transmission timing setting section 73 moves to step S403 of FIG. 10, removes the identified vehicle 10 from the group, and performs an update data transmission process shown in step S404 of FIG. 10. The update data transmission process is composed of steps S105 to S109 shown in FIG. 7.

The above-described action can prevent the initiation of updating immediately before a reserved operation starting time.

The vehicles 10 have been explained as self-driving taxies to which reserved operations can be allocated, but the vehicles 10 are not limited to self-driving taxies, and may, for example, be shared vehicles used in a car sharing system for performing reservation based operations.

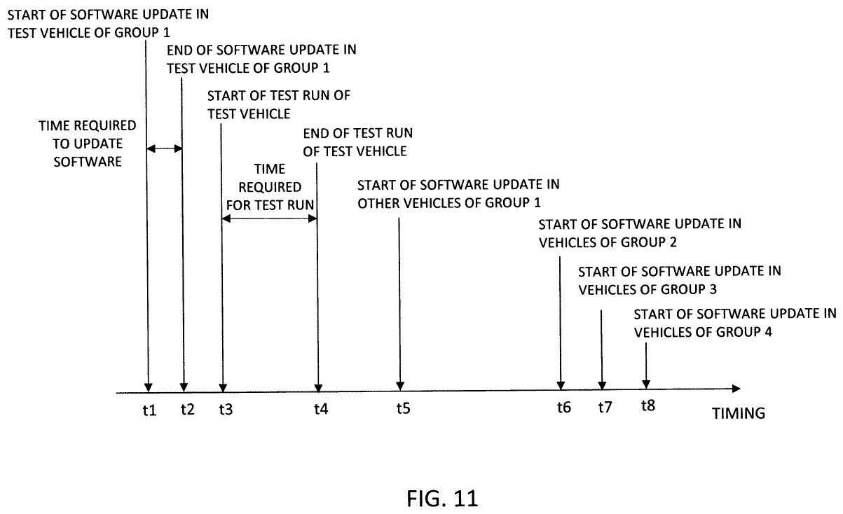

Next, action of updating the software in the vehicle controller 20 of each of the vehicles 10 is described with reference to FIG. 11. The action includes selecting as a test vehicle one among the vehicles 10 perked in the parking space 82, causing the test vehicle to perform a test run after performing an update of the software in a vehicle controller 20 of the test vehicle, and performing an update of the software in the vehicle controller 20 of each of the vehicles 10 other than the test vehicle.

In FIG. 7, the location information processing section 71 acquires location information from each of the vehicles 10 in step S101, identifies from the vehicles 10 those parked in the parking space 82 as shown in step S102 of FIG. 7, and selects one of the identified vehicles 10 as the test vehicle. The grouping processing section 72 groups, as shown in step S103 of FIG. 7, the identified vehicles 10 into a plurality of groups. The update data transmission timing setting section 73 sets, in step S104 of FIG. 7, the transmission timing of transmitting the update data to each of the group as explained below.

The update data transmission timing setting section 73 defines a group including the selected test vehicle as a first group which is, among the plurality of groups, initially subjected to software updating. Then, the update data transmission timing setting section 73 sets a transmission timing of transmitting the update data to the test vehicle so as to cause a vehicle controller 20 mounted on the test vehicle in the first group to initiate an update of software at a first timing t1 shown in FIG. 11 that precedes by a predetermine length of time an update of the software installed in each of vehicle controllers 20 mounted on remaining other vehicles 10 in the first group.

Then, for the vehicles 10 contained in the first group other than the test vehicle, the update data transmission timing setting section 73 sets a transmission timing of transmitting the update data so as to initiate the update of the software at a second timing t5 after the predetermined length of time from the first timing t1 as shown in FIG. 11. Here, the predetermined length of time is the sum of a length of time required to update the software in the vehicle controller 20 of the test vehicle; i.e., a time period between the timing t1 and a timing t2 shown in FIG. 11 and a length of time required to perform the test run of the test vehicle; i.e., a time period between a timing t3 and a timing t4 shown in FIG. 11.

Subsequently, the update data transmission timing setting section 73 sets transmission timings of transmitting the update data to each of vehicles 10 contained in following second to fourth groups, which are sequentially subjected to the update of software after the first group, so as to initiate the update of the software at timings t6 to t8 after the second timing t5, the timings t6 to t8 being varied on a group-by-group basis.

When the timing of transmission to each of the vehicles 10 is set on a group-by-group basis as described above, the update of the software in each of the vehicle controllers 20 is initiated in the other vehicles 10 in the first group after the completion of both the update of the software in the vehicle controller 20 of the test vehicle and the test run of the test vehicle. Therefore, in case of an error in updated software, and driving of the test vehicle being disabled accordingly as a result of the error, a situation in which all of the vehicles 10 are rendered undrivable due to the error can be prevented.

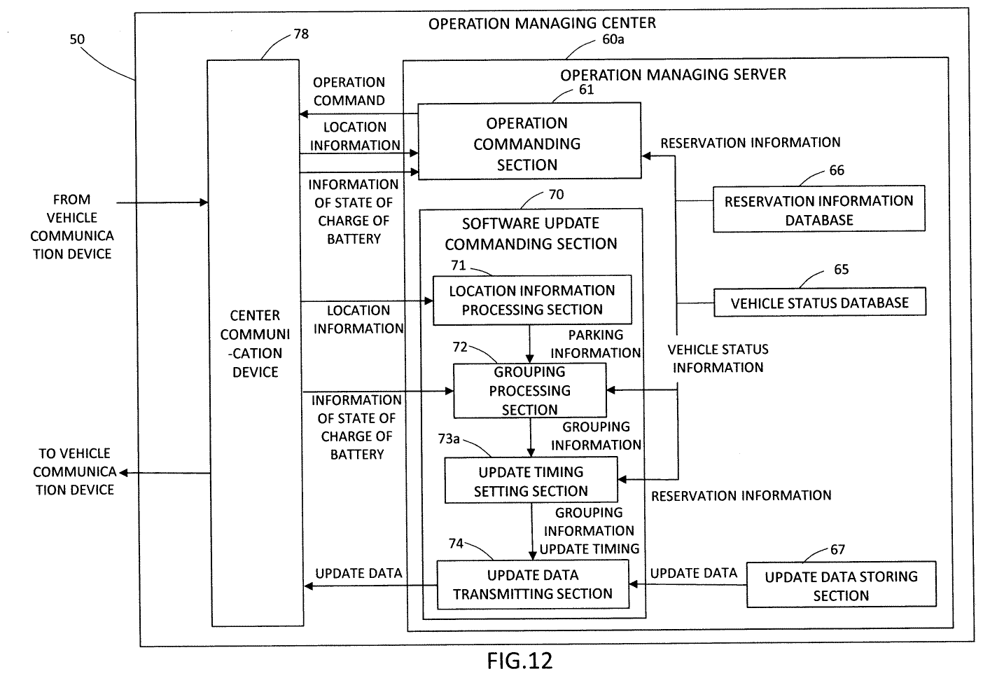

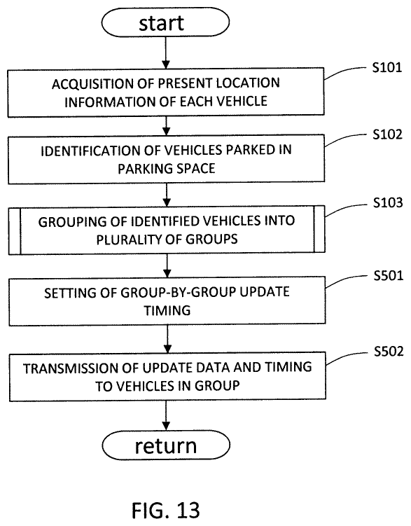

Hereinafter, a configuration and action of an operation managing server 60a according to another embodiment will be described with reference to FIGS. 12 and 13. In the following description, components and steps identical to those explained above with reference to FIGS. 1 to 7 are designated by the identical reference signs as those in FIGS. 1 to 7, and the description related to the components and steps will not be repeated.

As shown in FIG. 12, the operation managing server 60a, in which the update data transmission timing setting section 73 previously explained with reference to FIG. 4 is replaced by an update timing setting section 73a, is configured to perform the grouping process with the grouping processing section 72 as shown in step S103 of FIG. 13, subsequently set the update timing on the group-by-group basis with the update timing setting section 73a in step S501 of FIG. 13, and then transmit, with the update data transmitting section 74, a combination of the update timing which is set by the update timing setting section 73a and the update data to the vehicles 10 in each of the groups. Here, the update timing denotes a time at which each of the vehicles 10 initiates the update of the software.

In each of the vehicles 10, when the specified update timing arrives, the software updating section 23 in the vehicle 10 outputs the software update command to the vehicle controlling section 21 for causing the vehicle controlling section 21 to update the software.

In the vehicle operating system 100 according to this embodiment, the timing of transmission of the update data to the vehicles 10 can be arbitrarily specified for each of the groups, which can improve flexibility in updating the software.

In the embodiments described above, it has been explained that the operation managing server 60 which manages the operations of the vehicles 10 transmits the update data for the software or the update timing to the vehicles 10, but the embodiment is not limited to such a configuration, and may be implemented with a server which does not manage the operations of the vehicles, but is instead configured to access the database in the operation managing server 60, and transmit the update data for the software or the update timing to the vehicles 10.

Hereinafter, a vehicle operating system 200 according to another embodiment will be described. The same components as those in the vehicle operating system 100 previously described with reference to FIGS. 1 to 13 are designated by the same reference numerals as those in the vehicle operating system 100, and the descriptions related to the components will not be repeated.

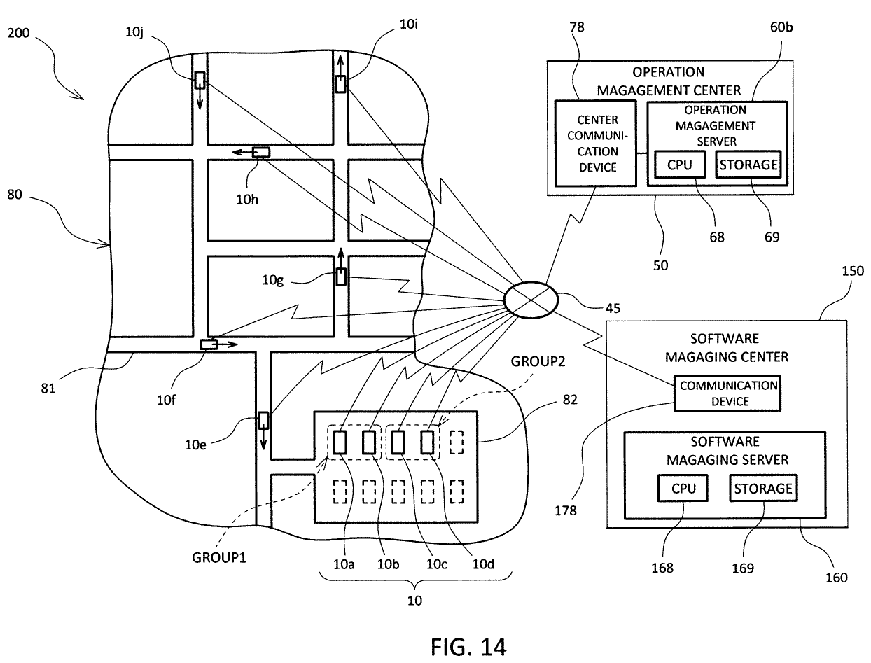

As shown in FIG. 14, the vehicle operating system 200 is obtained by additionally including a software managing center 150 in the vehicle operating system 100 previously explained with reference to FIG. 1. The software managing center 150 manages updates of software installed in the vehicle controllers 20 mounted on the vehicles 10, and includes a software managing server 160 and a communication device 178 to perform data transmission between the vehicles 10 and an operation managing server 60b via the wireless communication channel 45. The software managing center 150 may be located, for example, in a facility of the manufacturer of the vehicles 10.

The software managing server 160 is a computer incorporating a CPU 168 and a storage 169. The storage 169 stores update data for the software. The software managing server 160 determines whether an update of the software is necessary, and transmits, when determining the update of the software necessary, the update data for the software via the wireless communication channel 45 to the vehicles 10. Further, in addition to transmitting the update data, the software managing server 160 transmits to the operation managing server 60b an update data transmission signal being information indicating that the update data is transmitted to the operation managing server 60b.

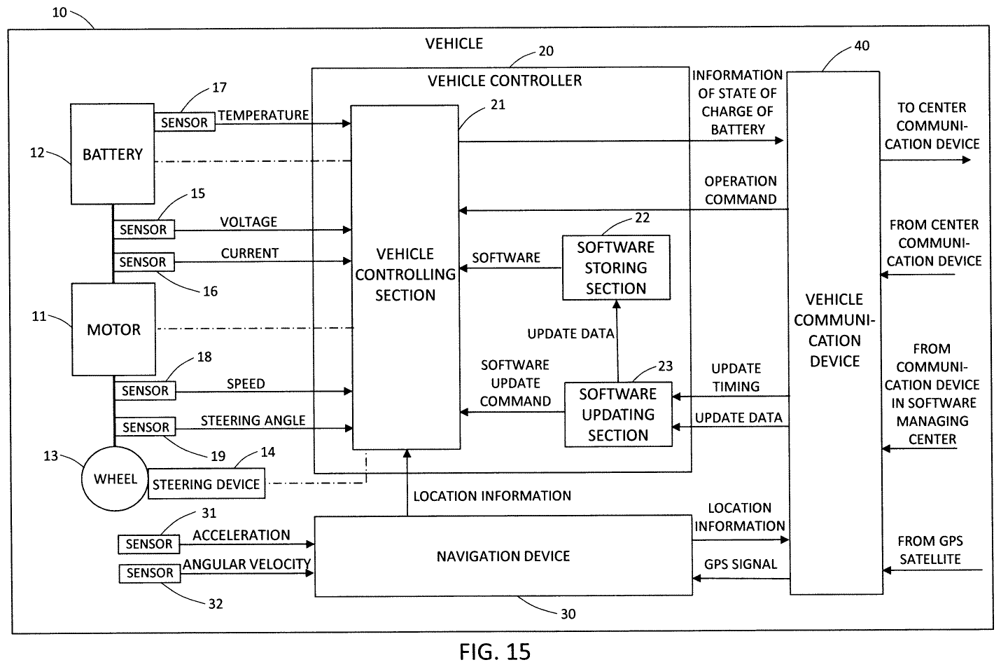

As shown in FIG. 15, the vehicles 10 in the vehicle operating system 200 have a configuration similar to that of the vehicles 10 in the vehicle operating system 100 other than a feature of communicating with the communication device 178 in the software managing center 150 to receive the update data from the software managing server 160.

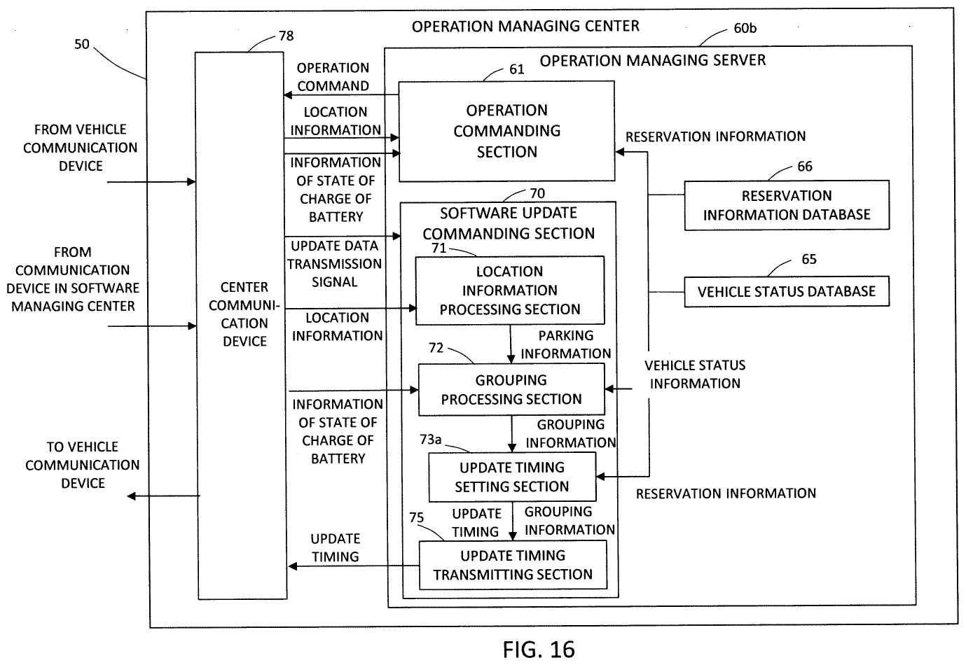

As shown in FIG. 16, the operation managing server 60b in the vehicle operating system 200, which is not configured to transmit the update data, lacks the update data storing section 67 contained in the operation managing server 60a previously explained with reference to FIG. 12, and also differs from the operation managing server 60a in that the operation managing server 60b includes an update timing transmitting section 75 in place of the update data transmitting section 74, and communicates with the software managing server 160 to receive the update data transmission signal from the software managing server 160. Otherwise, the operation managing server 60b is identical to the operation managing server 60a.

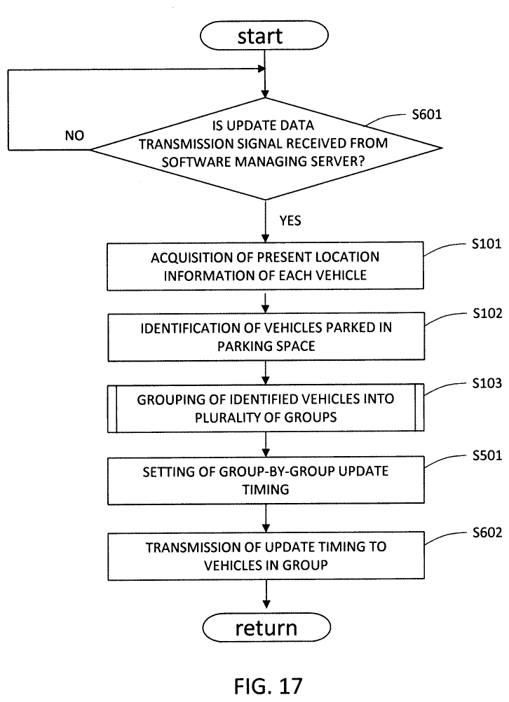

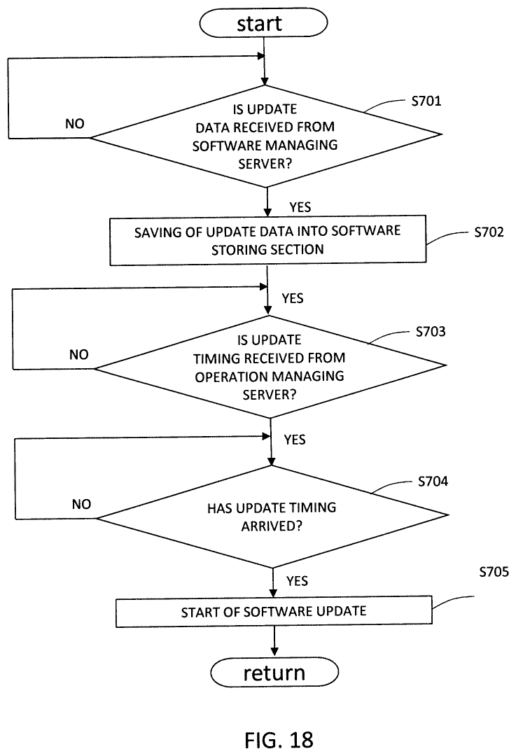

Hereinafter, action of the operation managing server 60b and action of the vehicle 10 are described with reference to FIGS. 17 and 18. In the following description, the same steps as those of the action shown in FIGS. 7 to 10 and 13 are designated by the same reference signs as those in FIGS. 7 to 10 and 13, and the descriptions related to the steps will not be repeated.

As shown in step S601 of FIG. 17, the operation managing server 60b waits until the update data transmission signal is received from the software managing server 160. Then, upon receipt of the update data transmission signal from the software managing server 160, the operation managing server 60b determines Yes in step S601 of FIG. 17, acquires information on the present locations of the vehicles 10 in step S101 of FIG. 17, and identifies, from the vehicles 10, those parked in the parking space 82 in step S102 of FIG. 17. Then, the operation managing server 60b groups the identified vehicles 10 into a plurality of groups in step S103 of FIG. 17. The grouping process is identical to that shown in FIG. 8 or 9.

The operation managing server 60b sets the update timing on a group-by-group basis in step S501 of FIG. 17, and transmits the specified update timing to the vehicles 10 in each of the groups in step S602 of FIG. 17.

As shown in step S701 of FIG. 18, the software updating section 23 in each of the vehicles 10 waits until the update data is received from the software managing server 160. Then, upon receipt of the update data from the software managing server 160, the software updating section 23 determines Yes in step S701 of FIG. 18, and moves to step S702 of FIG. 18 to store the received update data in the software storing section 22. The software updating section 23 moves to step S703 of FIG. 18 and waits until the update timing is transmitted from the operation managing server 60b. Then, upon receipt of the update timing, the software updating section 23 determines Yes in step S703, moves to step S704 of FIG. 18, and waits until the update timing arrives. Then, at the update timing, the software updating section 23 determines Yes in step S704 of FIG. 18, moves to step S705 of FIG. 18, and outputs the software update command to the vehicle controlling section 21 for causing the vehicle controlling section 21 to update the software.

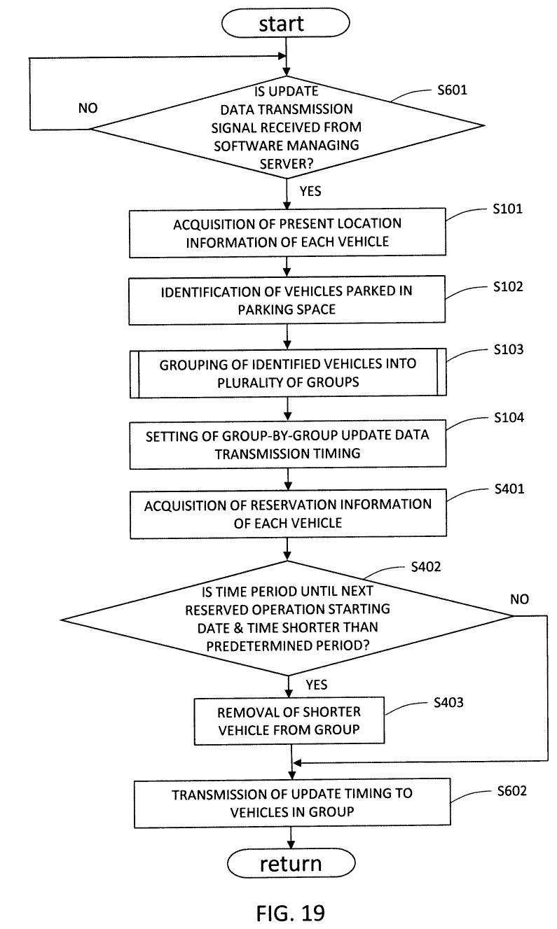

Hereinafter, another action of the operation managing server 60b is explained with reference to FIG. 19. In the following description, the same steps as those of the action shown in FIGS. 7 to 10 and 13 are designated by the same reference signs as those of the action in FIGS. 7 to 10 and 13, and the descriptions related to the steps will not be repeated.

In the action shown in FIG. 19, the operation managing server 60b waits until the update data transmission signal is received from the software managing server 160 in step S601 of FIG. 19, and upon receipt of the update data transmission signal, performs processing in steps S101 to S104 and S401 to S403 explained with reference to FIGS. 7 to 10. Then, the operation managing server 60b transmits the update timing to each of the vehicles 10 in each of the groups in step S602 of FIG. 19.

After receiving the update data from the software managing server 160, the vehicles 10 wait, as explained with reference to FIG. 18, until the update timing is received from the operation managing server 60b, after receiving the update timing, again wait until the update timing arrives, and update the software at the update timing.

In the above explanation, it is described that the software managing server 160 transmits the update data transmission signal being the information indicating that the update data is transmitted to the operation managing server 60b, and the operation managing server 60b performs, upon receipt of the update data transmission signal, the grouping process and setting of the update timings, while the software managing server 160 and the operation managing server 60b are not limited to the above-described configuration. For example, the operation managing server 60b may be configured to access the software managing server 160 at a predetermined time interval for acquiring information about whether the update data is transmitted, and after acquiring the information indicating that the update data is transmitted from the software managing server 160, perform the grouping process and the setting of the update timings. Here, the information may be a flag indicative of completion of transmission of the update data stored in the storage 169 of the software managing server 160.

As has been described above, the vehicle operating system 200 according to the above embodiment can prevent concurrent updating of the software installed in the vehicle controllers 20, to thereby secure the operations of the vehicles 10.

1. A software updating method, comprising:
transmitting update data for software in vehicle controllers via wireless communication from a server to a plurality of vehicles on which the vehicle controllers are respectively mounted, for causing each of the vehicle controllers to update the software;
wherein the server is configured to:
group the plurality of vehicles into a plurality of groups, and
vary timings of causing the vehicle controllers to update the software on a group-by-group basis.

2. The software updating method according to claim 1, wherein the server is further configured to vary transmission timings of transmitting the update data to the plurality of vehicles on a group-by-group basis.

3. The software updating method according to claim 1,
wherein the server is further configured to:
set an update timing of causing the vehicle controllers mounted on the vehicles in each of the plurality of groups to update the software in such a manner that the update timing is varied on a group-by-group basis; and
transmit both the update data ant the update timing to the vehicles in each of the plurality of groups.

4. The software updating method according to claim 2,
wherein the server is an operation managing server which manages operations of the plurality of vehicles; and
wherein the operation managing server is configured to:
acquire information on present locations from the plurality of vehicles,
identify, among the plurality of vehicles, two or more vehicles parked in a parking space, and
group the identified two or more vehicles into a plurality of groups.

5. The software updating method according to claim 3,
wherein the server is an operation managing server which manages operations of the plurality of vehicles; and
wherein the operation managing server is configured to,
acquire information on present locations from the plurality of vehicles,
identify, among the plurality of vehicles, two or more vehicles parked in a parking space, and
group the identified two or more vehicles into a plurality of groups.

6. A software updating method, comprising:
transmitting update data for software in vehicle controllers via wireless communication from a software managing server to a plurality of vehicles on which the vehicle controllers are respectively mounted, for causing each of the vehicle controllers to update the software;
wherein the software managing server is configured to transmit the update data to the plurality of vehicles, and
wherein an operation managing server which manages operations of the plurality of vehicles is configured to
acquire from the software managing server information indicating that the update data is transmitted,
group the plurality of vehicles into a plurality of groups upon acquisition of the information, and
vary timings of causing the vehicle controllers to update the software on a group-by-group basis.

7. The software updating method according to claim 6,
wherein the operation managing server is configured to:
set an update timing of updating the software in vehicle controllers mounted on vehicles in each of the plurality of groups, the update timing being varied on a group-by-group basis, and
transmit the update timing to the vehicles in each of the groups, and
wherein each of the vehicle controllers is configured to update the software upon receipt of the update timing.

8. The software updating method according to claim 7,
wherein the operation managing server is further configured to:
acquire information on present locations from the plurality of vehicles;
identify, among the plurality of vehicles, two or more vehicles parked in a parking space; and
group the identified two or more vehicles into a plurality of groups.

9. The software updating method according to claim 4,
wherein the plurality of vehicles are battery electric vehicles; and
wherein the operation managing server is further configured to:
acquire information on a present state of charge of a battery from each of the plurality of vehicles, and
group the two or more vehicles parked in the parking space into a plurality of groups in such a manner that vehicles having batteries whose state of charge differ from each other are contained in a same one group.

10. The software updating method according to claim 5,
wherein the plurality of vehicles are battery electric vehicles; and
wherein the operation managing server is further configured to:
acquire information on a present state of charge of a battery from each of the plurality of vehicles, and
group the two or more vehicles parked in the parking space into a plurality of groups in such a manner that vehicles having batteries whose state of charge differ from each other are contained in a same one group.

11. The software updating method according to claim 8,
wherein the plurality of vehicles are battery electric vehicles; and
wherein the operation managing server is further configured to,
acquire information on a present state of charge of a battery from each of the plurality of vehicles, and
group the two or more vehicles parked in the parking space into a plurality of groups in such a manner that vehicles having batteries whose state of charge differ from each other are contained in a same one group.

12. The software updating method according to claim 4,
wherein the operation managing server comprises a vehicle status database which stores maintenance statuses of the plurality of vehicles, and
wherein the operation managing server is configured to group the two or more vehicles parked in the parking space into a plurality of groups in such a manner that, among the plurality of vehicles, vehicles having different time periods until a next scheduled maintenance are contained in a same one group.

13. The software updating method according to claim 5,
wherein the operation managing server comprises a vehicle status database which stores maintenance statuses of the plurality of vehicles, and
wherein the operation managing server is configured to group the two or more vehicles parked in the parking space into a plurality of groups in such a manner that, among the plurality of vehicles, vehicles having different time periods until a next scheduled maintenance are contained in a same one group.

14. The software updating method according to claim 8,
wherein the operation managing server comprises a vehicle status database which stores maintenance statuses of the plurality of vehicles, and
wherein the operation managing server is configured to group the two or more vehicles parked in the parking space into a plurality of groups in such a manner that, among the plurality of vehicles, vehicles having different time periods until a next scheduled maintenance are contained in a same one group.

15. The software updating method according to claim 4,
wherein the plurality of vehicles are a plurality of self-driving taxies;
wherein the operation managing server comprises a reservation information database which stores information on reservations of the plurality of self-driving taxies; and
wherein the operation managing server is configured to group, among the plurality of self-driving taxies, self-driving taxies parked in the parking space into a plurality of groups based on the information on reservations.

16. The software updating method according to claim 5,
wherein the plurality of vehicles are a plurality of self-driving taxies;
wherein the operation managing server comprises a reservation information database which stores information on reservations of the plurality of self-driving taxies; and
wherein the operation managing server is configured to group, among the plurality of self-driving taxies, self-driving taxies parked in the parking space into a plurality of groups based on the information on reservations.

17. The software updating method according to claim 8,
wherein the plurality of vehicles are a plurality of self-driving taxies;
wherein the operation managing server comprises a reservation information database which stores information on reservations of the plurality of self-driving taxies; and
wherein the operation managing server is configured to group, among the plurality of self-driving taxies, self-driving taxies parked in the parking space into a plurality of groups based on the information on reservations.

18. The software updating method according to claim 4,
wherein the plurality of vehicles are a plurality of shared vehicles;
wherein the operation managing server comprises a reservation information database which stores information on reservations of the plurality of shared vehicles; and
wherein the operation managing server is configured to group, among the plurality of shared vehicles, shared vehicles parked in the parking space into a plurality of groups based on the information on reservations.

19. The software updating method according to claim 5,
wherein the plurality of vehicles are a plurality of shared vehicles;
wherein the operation managing server comprises a reservation information database which stores information on reservations of the plurality of shared vehicles; and
wherein the operation managing server is configured to group, among the plurality of shared vehicles, shared vehicles parked in the parking space into a plurality of groups based on the information on reservations.

20. The software updating method according to claim 8,
wherein the plurality of vehicles are a plurality of shared vehicles;
wherein the operation managing server comprises a reservation information database which stores information on reservations of the plurality of shared vehicles; and
wherein the operation managing server is configured to group, among the plurality of shared vehicles, shared vehicles parked in the parking space into a plurality of groups based on the information on reservations.

21. The software updating method according to claim 2,
wherein the server is an operation managing server which manages operations of the plurality of vehicles;
wherein the operation managing server is configured to
acquire information on present locations from the plurality of vehicles,
identify, among the plurality of vehicles, two or more vehicles parked in a parking space,
group the identified two or more vehicles into a plurality of groups,
transmit the update data for the software to a test vehicle in a first group which is, among the plurality of groups, initially subjected to an update of the software, so as to cause a vehicle controller mounted on the test vehicle to perform the update of the software at a first timing preceding by a predetermined length of time an update of the software in vehicle controllers mounted on other vehicles in the first group,
transmit the update data to the other vehicles in the first group so as to cause the vehicle controllers of the other vehicles to perform the update of the software at a second timing after the predetermined length of time from the first timing, and
transmit the update data to vehicles in each of second and subsequent groups in the plurality of groups so as to cause vehicle controllers of the vehicles in the second and subsequent groups to sequentially perform the update of the software at timings subsequent to the second timing, the timings being varied on a group-by-group basis,
wherein the predetermined length of time is a sum of a length of time required to update the software in the vehicle controller mounted on the test vehicle and a length of time required to perform a test run of the test vehicle after the update of the software.

22. The software updating method according to claim 3,
wherein the server is an operation managing server which manages operations of the plurality of vehicles;
wherein the operation managing server is configured to
acquire information on present locations from the plurality of vehicles,
identify, among the plurality of vehicles, two or more vehicles parked in a parking space,
group the identified two or more vehicles into a plurality of groups,
set an update timing of updating the software in a vehicle controller mounted on a test vehicle in a first group which is, among the plurality of groups, initially subjected to an update of the software, so as to cause the vehicle controller mounted on the test vehicle to perform the update of the software at a first timing preceding by a predetermined length of time an update of the software in vehicle controllers of other vehicles in the first group,
set an update timing of updating the software in the vehicle controllers of the other vehicles, so as to cause the vehicle controllers of the other vehicles to perform the update of the software at a second timing after the predetermined length of time from the first timing, and
set an update timing of updating the software in vehicle controllers mounted on vehicles in each of second and subsequent groups in the plurality of groups, so as to cause the vehicle controllers of the vehicles in the second and subsequent groups to sequentially update the software at timings subsequent to the second timing, the timings being varied on a group-by-group basis; and
wherein the predetermined length of time is a sum of a length of time required to update the software in the vehicle controller mounted on the test vehicle and a length of time required to perform a test run of the test vehicle after completion of the update of the software.

23. The software updating method according to claim 8,
wherein the operation managing server is further configured to:
acquire information on present locations from the plurality of vehicles;
identify, among the plurality of vehicles, two or more vehicles parked in a parking space;
group the identified two or more vehicles into a plurality of groups;
set an update timing of updating the software in a vehicle controller mounted on a test vehicle in a first group which is, among the plurality of groups, initially subjected to an update of the software, so as to cause the vehicle controller mounted on the test vehicle to perform the update of the software at a first timing preceding by a predetermined length of time an update of the software in other vehicles contained in the first group,
set an update timing of updating the software in vehicle controllers mounted on the other vehicles in the first group, so as to cause the vehicle controllers of the other vehicles to perform the update of the software at a second timing after the predetermined length of time from the first time, and
set an update timing of updating the software in vehicle controllers mounted on vehicles in each of second and subsequent groups in the plurality of groups, so as to cause the vehicle controllers of the vehicles in the second and subsequent groups to sequentially update the software at timings subsequent to the second timing, the timings being varied on a group-by-group basis; and
wherein the predetermined length of time is a sum of a length of time required to update the software in the vehicle controller of the test vehicle and a length of time required to perform a test run of the test vehicle after the software is updated.

24. A vehicle operating system, comprising:
a plurality of vehicles on which vehicle controllers are respectively mounted; and
an operation managing server which manages operations of the plurality of vehicles,
wherein the operation managing server is configured to transmit update data for software in the vehicle controllers mounted on the plurality of vehicles via wireless communication to the plurality of vehicles;
wherein each of the vehicle controllers respectively mounted on the plurality of vehicles is configured to update the software upon receipt of the update data transmitted from the operation managing server, and
wherein the operation managing server is further configured to
group the plurality of vehicles into a plurality of groups, and
vary timings of causing the vehicle controllers to update the software on a group-by-group basis.

25. The vehicle operating system according to claim 24,
wherein the operation managing server is further configured to vary transmission timings of transmitting the update data to the plurality of vehicles on a group-by-group basis.

26. The vehicle operating system according to claim 24,
wherein the operation managing server is further configured to:
set update timings of updating the software in such a manner that the software is updated in vehicle controllers mounted on vehicles contained in each of the plurality of groups at a different update timing that is varied on a group-by-group basis, and
transmit both the update data and the update timing to the vehicles.

27. The vehicle operating system according to claim 25,
wherein the operation managing server is further configured to:
acquire information on present locations from the plurality of vehicles;
identify, among the plurality of vehicles, two or more vehicles parked in a parking space; and
group the identified two or more vehicles into a plurality of groups.

28. The vehicle operation system according to claim 26,
wherein the operation managing server is further configured to:
acquire information on present locations from the plurality of vehicles;
identify, among the plurality of vehicles, two or more vehicles parked in a parking space; and
group the identified into a plurality of groups.

29. A vehicle operating system, comprising:
a plurality of vehicles on which vehicle controllers are respectively mounted;
an operation managing server which manages operations of the plurality of vehicles; and
a software managing server which transmits update data for software in the vehicle controllers via wireless communication to the plurality of vehicles;
wherein the operation managing server is further configured to,
acquire from the software managing server information indicating that the update data is transmitted,
group, upon acquisition of the information, the plurality of vehicles into a plurality of groups, and
vary timings of causing the vehicle controllers to update the software on a group-by-group basis.

30. The vehicle operating system according to claim 29,
wherein the operation managing server is further configured to:
set an update timing of updating the software in vehicle controllers mounted on vehicles contained in each of the plurality of groups, the update timing being varied on a group-by-group basis, and
transmit the update timing to the vehicles; and
wherein each of the vehicle controllers is configured to update the software upon receipt of the update timing.

31. The vehicle operating system according to claim 30,
wherein the operation managing server is further configured to:
acquire information on present locations from the plurality of vehicles;
identify, among the plurality of vehicles, two or more vehicles parked in a parking space, and
group the identified two or more vehicles into a plurality of groups.
